(19) United States
(12) Patent Application Publication
(10) Pub. No.: US 2018/0330404 A1
(43) Pub. Date: Nov. 15, 2018

(54) REAL-TIME TECHNOGRAPHIC ADVERTISEMENT

(71) Applicant: Engine Media, LLC, Princeton, NJ (US)

(72) Inventor: Dominic Bennett, Los Altos, CA (US)

(73) Assignee: Engine Media, LLC, Princeton, NJ (US)

(21) Appl. No.: 15/979,737

(22) Filed: May 15, 2018

Related U.S. Application Data
(60) Provisional application No. 62/506,249, filed on May 15, 2017.

(51) Int. Cl. G06Q 30/02

(52) U.S. Cl. CPC G06Q 30/0267; G06Q 30/0261

(57) ABSTRACT

Real-time technographic advertisement is disclosed. For example, a network accessible device is selected to receive an advertisement, and a determination is made that the network accessible device is in use by a user. In response to determining that the network accessible device is in use by the user, a current state of operation of the network accessible device is determined based on a plurality of device attributes of the network accessible device, which are based on measureable physical characteristics of the network accessible device. In response to determining that the current state of operation is a first state, the advertisement is sent to the network accessible device. In response to determining that the current state of operation is a second state, either the current state of operation is reevaluated or the network accessible device is deselected for receiving the advertisement.

### CROSS REFERENCE TO RELATED APPLICATION

The present application is a non-provisional of U.S. Provisional Application Ser. No. 62/506,249, filed May 15, 2017, the entire disclosure of which is hereby incorporated by reference herein.

### BACKGROUND

The present disclosure generally relates to advertising on network accessible devices. As microprocessors have become more efficient, and network connectivity more prevalent, an ever increasing amount of devices now have internet or intranet enabled capabilities and features. With the network capabilities of network accessible devices, come opportunities for users to consume content, and therefore opportunities for publishers of content to advertise to these users. Advertisers desire to maximize the value of their advertising investments, while users desire maximum value added from the advertisements (“ads”) they consume while minimizing time wasted consuming advertisements in place of content. As content accessed by network accessible devices is typically served on demand by the user, the quality of a user experience may correlate with properly matching users with desirable products and services.

### SUMMARY

The present disclosure provides a new and innovative system, methods and apparatus for real-time technographic advertisement. In an example, a network accessible device is selected to receive an advertisement, and a determination is made that the network accessible device is in use by a user. In response to determining that the network accessible device is in use by the user, a current state of operation of the network accessible device is determined based on a plurality of device attributes of the network accessible device, which are based on measureable physical characteristics of the network accessible device. In response to determining that the current state of operation is a first state, the advertisement is sent to the network accessible device. In response to determining that the current state of operation is a second state, either the current state of operation is reevaluated or the network accessible device is deselected for receiving the advertisement.

Additional features and advantages of the disclosed method and apparatus are described in, and will be apparent from, the following Detailed Description and the Figures.

### BRIEF DESCRIPTION OF THE FIGURES

FIG. 1 is a block diagram of a real-time technographic advertisement system 100 for use by a user 190 according to an example of the present disclosure.

FIG. 2A is a block diagram of the outside of a real-time technographic advertisement network accessible device according to an example of the present disclosure.

FIG. 2B is a block diagram of the internals of a real-time technographic advertisement network accessible device according to an example of the present disclosure.

FIGS. 3A-D are block diagrams of a real-time technographic advertisement system according to an example of the present disclosure.

FIG. 4 is a flowchart illustrating an example of real-time technographic advertisement according to an example of the present disclosure.

FIG. 5 is a flow diagram illustrating advertisement delivery based on a state of a network accessible device according to an example of the present disclosure.

FIG. 6 is a flow diagram illustrating reactive advertisement delivery based on device attributes of a network accessible device according to an example of the present disclosure.

FIG. 7 is a flow diagram illustrating location sensitive advertisement delivery according to an example of the present disclosure.

### DETAILED DESCRIPTION OF EXAMPLE EMBODIMENTS

The concept of connecting sensors that provide feedback over a network related to key operational components of a device is a concept that evolved parallel to the internet. Many features of network accessible devices also rely on input/output (“I/O”) data to and from a variety of sensors on the network accessible devices. As an ever increasing amount of devices that people interact with on a daily basis become network accessible devices, an opportunity is presented to leverage sensor I/O data from these network accessible devices to deliver more valuable advertising more efficiently to a target audience. This target audience may also be identified with greater accuracy based on the same sensor I/O data, especially when combined with historical data related to a user's internet searches and purchases. In various examples, such sensor data may enhance the user experience and delivery efficiency of any form of content that may be presented on a device, for example, educational videos, entertainment videos, news, games, etc.

With the vast variety of devices capable of displaying audio and visual advertisements, come implementation challenges, especially as related to accurately determining whether a given advertising attempt has reached a targeted user. With a variety of devices, also comes a variety of preferential formats for advertising in each format, for example, a smart phone, a smart watch, and a tablet may be interacted with differently from a laptop or desktop computer, which may in turn be interacted with vastly differently from, for example, a display on a vending machine or a console in a car.

A strategy that may be used to try to reach members of a target audience may be to saturate publishers of content consumed by such a target audience with advertising slot purchases. However, such purchases fail to efficiently convert advertising slot purchases into viewed advertisements. Similarly, targeting a network accessible device for an advertisement may fail to reach the proper user of a shared device. In a typical scenario, advertisements targeting such wide audiences may also fail to produce positive user engagement, often being considered irrelevant nuisances by their recipients.

Typically, a publisher serving content may coordinate with advertisers using a bidding process to display ads in content served to consumers of the publisher's content. A page of content, such as a web page on a web site, may include multiple ad slots where ads may be displayed. In an example, each ad slot, when loaded to a client device and viewed by a user of the client device may result in an ad impression. An ad impression may be an opportunity for an advertiser to reach a given user at a given time, and therefore each time a user loads a given page of content, and/or each time a different user loads the page of content, each ad slot on the page may become a new ad impression. In an example, a publisher may therefore request for advertisers to bid on each ad impression to maximize the value of each respective ad impression. For advertisers, ad agencies, and/or ad exchanges, response time to requests for bids on ad impressions may therefore be critical for maximizing both the likelihood of securing an ad impression as well as the effectiveness of a given ad impression. As users typically expect perceivably immediate responses when accessing content online, the entire process for negotiating, selecting, and displaying an ad may typically be completed in under one second. In a typical day, billions of ads may be served to consumers on network accessible devices. Publishers may be incentivized to maximize the quantity of advertisers bidding on each of their ad impressions to generate maximum value from each impression.

In a typical advertising exchange implementation, a user on a network accessible client device may access content supplied by a publisher. The publisher may incorporate ad slots in the content, and then seek prospective buyers (e.g., advertisers) for the ad impressions in the content in real-time while the content is loading, for example, by broadcasting an ad request for each ad slot loaded to the client device as an ad impression. An ad agency may, upon receipt of a request to bid on a given ad slot, seek advertisers either directly or through an advertising exchange to purchase the ad slot. For example, header bidding may be a typical implementation by which publishers and ad agencies request bids for and subsequently serve advertisements. A typical header bidding implementation may be based on the open source project Prebid.js where a typical request for bids on an ad slot may be in the form of a hypertext transfer protocol (“HTTP”) GET request with query string parameters related to the particular ad slot, such as a tag id, a referrer, and a size of the ad impression. For example, a header bidding request may be in the form of a Uniform Resource Locator (“URL”) without an additional message payload such as, http://www.example.com/getBid?tagid=55&referrer=mysite.com&width=300&height=250. In an example, an HTTP header associated with a request may include additional information pertinent to the request, such as User Agent, Content Type, Content Length, etc. In an example, requests for bids on an ad slot may also be in the form of an HTTP POST request. For example, in implementations based on the open source project OpenRTB, a bid may be in the form of an HTTP POST request with a JavaScript Object Notation (“JSON”) payload. A typical JSON payload for an ad slot bid may include attribute-value pairs conveying information regarding the particular ad slot, such as, {“tagid”; “55”, “referrer”: “mysite.com”, “dimensions”: {“width”: “300”, “height”: “250”}}. In various examples, different publishers and advertisers may implement different preferred formats of advertisement requests.

The present disclosure aims to address the delivery challenges for advertising on various network accessible devices by leveraging available sensor I/O data from such devices to define a technographic state of the device which may be leveraged to deliver targeted, beneficial, customized advertisements with an increased conversion rate of advertisement attempts to advertisements consumed. In an example, physical characteristics of a network accessible device may be measured and/or inferred from various sensor I/O data from the device. For example, a light sensor may show that even though a device is currently streaming a video, the device is likely in a pocket because the screen is in the dark. In the example, a visual centric advertisement delivered to the device would likely be ignored, resulting in a failed advertisement slot purchase. However, with the additional information that a Bluetooth® headset is connected, a determination may be made that the user may be listening to the audio track from the video being streamed, and may be receptive to an alternative audio advertisement. Additional sensor data from a Global Positioning System (“GPS”) sensor may identify that the user is on a mountain road, while gyroscope and accelerometer data may indicate that the user is driving, cycling, or jogging. With the additional physical characteristics of the network accessible device from these sensors contributing to a technographic state of the network accessible device, the user may be identified as being in a receptive state, but limited to audio advertisements. In such a situation, rather than having a video of steam rising from a fresh baked pie sent to the network accessible device based on its ownership by a married woman between 30 and 45 years of age with two children, an audio advertisement for a professional grade mountain bike may be delivered instead. With access to the additional sensor data to determine a current state of operation of the network accessible device, advertisements may be delivered with high specificity and for items and services pertinent to the user's current needs, with likely a much higher conversion rate of advertisement slots purchased to advertisements consumed. By employing real-time technographic advertisement as disclosed in the present disclosure, user specific content (e.g., advertisements) may be generated that dynamically adapt to environmental changes in a network accessible device (e.g., changing states), thereby creating a user experience previously unobtainable while simultaneously streamlining content delivery to allow for higher quality, bespoke, value added placements in place of delivering commoditized mass produced content. Therefore real-time technographic advertisement as disclosed improves upon existing methods of computerized content distribution and generation. In addition, real-time technographic advertisement enables publishers and advertisers to dynamically alter the content (e.g., ads or publisher content) delivered to a user in the process of and during the course of delivery, including, optionally, to cancel delivery and preserve computing and networking bandwidth.

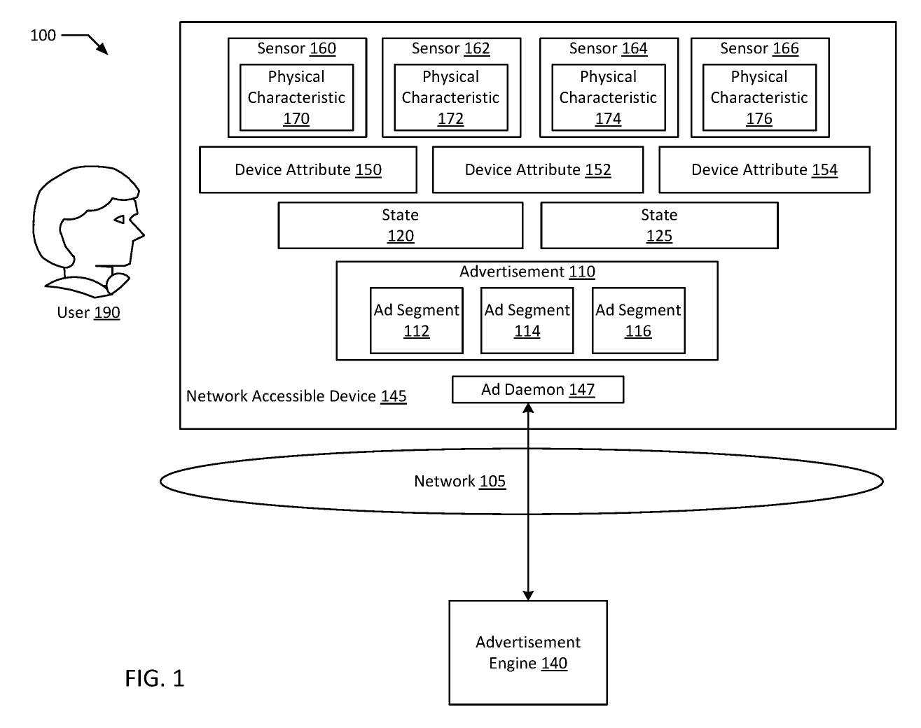

FIG. 1 is a block diagram of a real-time technographic advertisement system 100 for use by a user 190 according to an example of the present disclosure. In an example, network accessible device 145 may be any form of network connected device from classic computing terminals (e.g., desktop and laptop computers), to mobile devices (e.g., tablets, cellular phones, smart watches, smart glasses, head-up displays, virtual reality displays), to Internet of Things (“IoT”) devices which may include household appliances (e.g., smart TVs, washers, driers, refrigerators, dishwashers, ovens, vacuum cleaners etc.). In various examples, network accessible device 145 may have a memory and one or more processors. As used herein, physical processor or processors (Central Processing Units “CPUs”) refer to devices capable of executing instructions encoding arithmetic, logical, and/or I/O operations. In one illustrative example, a processor may follow Von Neumann architectural model and may include an arithmetic logic unit (ALU), a control unit, and a plurality of registers. In an example, a processor may be a single core processor which is typically capable of executing one instruction at a time (or process a single pipeline of instructions), or a multi-core processor which may simultaneously execute multiple instructions. In another example, a processor may be implemented as a single integrated circuit, two or more integrated circuits, or may be a component of a multi-chip module (e.g., in which individual microprocessor dies are included in a single integrated circuit package and hence share a single socket). A processor may also be referred to as a central processing unit (CPU). As discussed herein, a memory device refers to a volatile or non-volatile memory device, such as RAM, ROM, EEPROM, or any other device capable of storing data.

In an example, network accessible device 145 includes a plurality of sensors (e.g., sensors 160, 162, 164, and 166) each of which may measure physical characteristics associated with the network accessible device, (e.g., physical characteristics 170, 172, 174, and 176). In an example, each of sensors 160, 162, 164, and 166 may be any type of device that allows network accessible device 145 to make measurements (e.g., a camera, a microphone, an accelerometer, an altimeter, an antenna, an audio jack, a battery life sensor, a compass, a light sensor, a Global Positioning System® (“GPS”) sensor, a gyroscope, and a radio). In such an example, physical characteristics 170, 172, 174, and 176 measured by sensors 160, 162, 164, and 166 may include, facial recognition data, audio sample recognition data, acceleration rates and vectors, altitude, cellular reception strength, background noise levels, battery life, heading, direction, ambient light conditions, longitude and latitude, motion sensing and short distance wireless signal strength (e.g., near field, Bluetooth®, WiFi, WiMax, etc.). In an example, some physical characteristics of network accessible device 145 may be innate and unchanging rather than measurable (e.g., device model, display resolution, supported transmission types, supported content types).

In an example, a plurality of device attributes (e.g., device attributes 150, 152, and 154), may be derived from the plurality of physical characteristics both measured (e.g., physical characteristics 170, 172, 174, and 176) and innate hardware characteristics of network accessible device 145. For example, device attributes 150, 152, and 154 may include a type of the network accessible device 145 (e.g., make and model), a display type, a display resolution, a geo-location, a movement status, an orientation status, a data transmission speed, a remaining battery capacity, a wireless signal type, and a wireless signal strength. In an example, network accessible device 145 may be in one of at least two states, states 120 and 125. States 120 and 125 may be based on a combination of various device attributes of network accessible device 145, including device attributes 150, 152, and 154. In an example, the state (e.g., states 120 and 125) of network accessible device 145 may indicate whether or not network accessible device 145 is currently receptive to receiving an advertisement. In an example, state 120 may be a first state which may be a receptive state while state 125 may be a second state which may be a non-receptive state. For example, network accessible device 145 may be determined to be in state 120 based on device attributes indicating that network accessible device 145 is powered on with greater than 50% battery life remaining, a WiFi connection, sound turned on and a screen brightness of 30% (e.g., indicative of current use in a low ambient light condition). In the alternative, network accessible device 145 may be determined to be in state 125 for a variety of factors, each of which may or may not be sufficient alone. In an example, a battery life reading under 5% may be a sufficient device attribute, (e.g., as a courtesy to the user 190 not to drain their remaining battery life on an advertisement and to avoid the possible interruption of the ad). In another example, a fingerprint used to unlock a device on a biometric scanner may not match a targeted user 190. Other examples may include, wireless signal being too weak to stream an advertisement at an acceptable quality and resolution, or turbulent motion indicating that the user 190 may be running etc. In an example, a device moving at a certain velocity may be determined to be on an automobile, while an additional device attribute, such as being connected to the automobile's Bluetooth® sound system may imply that the user 190 is driving. In such an example, a video ad may be avoided as potentially unsafe. However, above a certain threshold speed, it may be determined that the device is on an aircraft, and that video may be acceptable or even appreciated.

In an example, network 105 may be any type of network, for example, a public network (e.g., the Internet), a private network (e.g., a local area network (LAN) or wide area network (WAN)), or a combination thereof. In an example devices connected through network 105 may be interconnected using a variety of techniques, ranging from a point-to-point processor interconnect, to a system area network, such as an Ethernet-based network. In an example, advertisement 110 may include a plurality of ad segments including ad segments 112, 114, and 116. In various examples, ad segments 112, 114, and 116 may be sequential segments of a complete advertisement 110, or alternative versions of one or more parts of an advertisement 110 that may be dynamically assembled to present a complete advertisement 110. In some examples, individual ad segments 112, 114, and 116 may be loaded to network device 145 at once. In other examples, ad segments 112, 114, and 116 may be loaded to network device 145 in an ad hoc manner with only required ad segments being loaded. For example, if ad segment 112 is the beginning of an ad, and ad segments 114 and 116 are alternative endings to the advertisement, ad segments 114 and 116 may be preloaded to network accessible device 145, with the proper ending being played based on, for example, device attributes 150, 152 and 154. In another example, an intervening change to at least one of device attributes 150, 152 and 154 during the playback of ad segment 112 may trigger the loading of ad segment 116 to replace ad segment 114. For example, the measured state of network accessible device 145 may include device attributes such as a facial recognition reading of user 190's expressions (e.g., smiling is a positive sign) or audio readings indicating, for example, that user 190 is laughing or singing along with the ad. In such an example, based on the positive feedback, a change may be recorded in the state of network accessible device 145 (e.g., changed to an “engaged” state from a “receptive” state). In such an example, another ad segment may be loaded and appended to the end of the ad continuing the positive experience for user 190. In an example, a negative reaction (e.g., a frown, or a growl), may result in an option to skip the ad or to display an alternative ad. In an example, sufficient negative reactions may result in user 190 being prompted to take a survey to better target ads.

In an example, advertisement 110 is delivered to network accessible device 145 by an advertisement engine 140. In an example, advertisement engine 140 may receive device attributes of network accessible device 145 over network 105. In an example, device attributes 150, 152, and 154 may be included in a handshake or a request to load content from a publisher. In an example, device attributes 150, 152, and 154 may be included in a hypertext transfer protocol (“HTTP”) browser cookie. In another example, user 190 may consent to directly sharing device attributes 150, 152, and 154 with advertisement engine 140 in exchange, for example, for less total advertisements shown or better quality advertisements shown. In an example, a publisher may implement a version of advertisement engine 140 for selecting and displaying content, including ads, to network accessible device 145. For example, a publisher may implement video content in a plurality of segments, and a segment may be interrupted with an ad based on a device state or measured physical characteristic. For example, a video playing may be interrupted to provide an emergency alert based on network connection (e.g., location determined by cell phone tower) or an ad for umbrellas based on GPS location data and weather data.

In an example, an ad daemon 147 may be deployed on network accessible device 145. The ad daemon 147 may be installed as part of an application (e.g., shopping application, browser, etc.) executing on network accessible device 145. In another example, ad daemon 147 may be included as part of the ad content of advertisement 110, or part of an initial handshake between advertisement engine 140 and network accessible device 145 to establish a network session for delivering network content. In an example, ad daemon 147 may be implemented in any suitable programming language (e.g., Java, C, C++, C-sharp, Visual Basic, structured query language (SQL), Pascal, common business oriented language (COBOL), business process execution language (BPEL), business process model notation (BPMN), complex event processing (CEP), jBPM, Drools, etc.). In an example, ad daemon 147 may be embeded in web content retrieved by network accessible device 145, for example, ad daemon 147 may be implemented with HTML5 or JavaScript executing in a browser on network accessible device 145. In an example, ad daemon 147 collects information on network accessible device 145, for example, physical characteristics 170, 172, 174, 176, device attributes 150, 152, 154, and/or states 120, 125 and communicates a report of these device characteristics of network accessible device 145 with advertisement engine 140. In an example, ad daemon 147 summarizes the data collected and communicates the summaries with advertisement engine 140. In an example, ad daemon 147 periodically probes for updates to physical characteristics 170, 172, 174, 176, device attributes 150, 152, 154, and/or states 120, 125, for example, multiple times per second during an advertising or content delivery exchange. In an example, ad daemon 147 determines a current state (e.g., state 120 or 125) of network accessible device 145. In an example, ad daemon 147 may implement different polling cycles for different attributes on independent threads. In the example, some attributes may update more or less frequently than others. For example, ad daemon 147 may flag a GPS sensor for high accuracy, which may trigger GPS readings 4 or more times per second, and therefore GPS location data may be updated by and to ad daemon 147 every 250 ms. In another example, ad daemon 147 may set a repeating timer to poll an attribute (e.g., 2, 3, 4, 5, . . . 10 times per second).

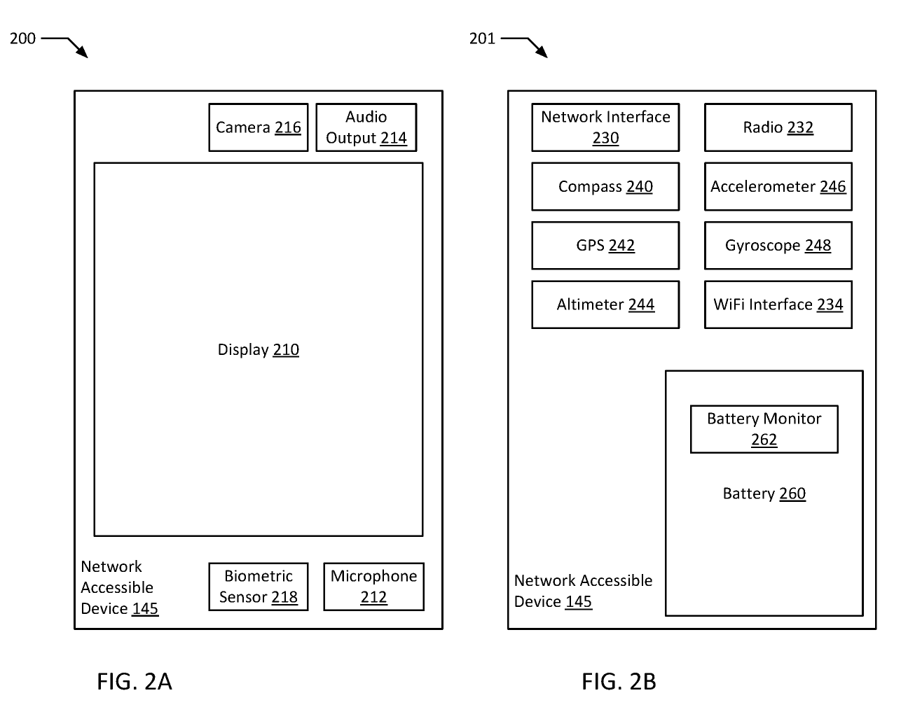

FIG. 2A is a block diagram of the outside of a real-time technographic advertisement network accessible device according to an example of the present disclosure. System 200 illustrates certain external features of network accessible device 145, which may be, for example, a smart phone. In the example, network accessible device 145 may include a display 210, a microphone 212, an audio output 214, camera 216, and a biometric sensor 218. In an example, display 210 may additionally include device attributes (e.g., resolution, brightness ratio, contrast ratio, three dimensional display capabilities, touch sensitive capabilities, etc.). Similarly, biometric sensor 218 may measure a variety of biometric signatures (e.g., fingerprint, retina scan, blood type, a genetic scan, etc.). Microphone 212 and audio output 214 may include device attributes related to frequency and amplitude of supported sound waves. In an example, a camera 216 may not only make photographic and video recordings, but may also be used to measure a device attribute such as a facial expression of the current user (e.g., through facial recognition), and may also include certain device attributes (e.g., resolution, focal length, flash capability, zoom capability, etc.). Camera 216 may also be an input triggering the display of advertisement 110, (e.g., through scanning a bar code indicating interest in a product). In an example, other sensors may be present for measuring ambient characteristics (e.g., temperature, light intensity, background noise levels, etc.)

FIG. 2B is a block diagram of the internals of a real-time technographic advertisement network accessible device according to an example of the present disclosure. System 201 illustrates certain internal components of network accessible device 145. In an example, network accessible device 145 may include a network interface 230, one or more radios 232, a WiFi interface 234, a compass 240, a GPS sensor 242, an altimeter 244, an accelerometer 246, a gyroscope 248, a battery 260 and a battery monitor 262. In an example, network interface 230 may include both wired and wireless networking capabilities. In an example, device attributes such as network bandwidth and latency may play a significant roll in determining a state (e.g., states 120 or 125) of network accessible device 145. In an example, radios 232 and WiFi interface 234 may be component parts of network interface 230, or separate components. In an example, radios 232 may include any type of radio, RF transmitter/receiver, or wireless communication technology (e.g., near field, Bluetooth®, WiFi, WiMax®, etc.). In an example, radios 232 may provide network connectivity and signal strength device attributes. In another example, radios 232 may provide location device attributes (e.g., a near field or Bluetooth® signal may indicate that a device is in or near a certain location such as a store). In the example, proximity may trigger the delivery of a flyer with current sales to network accessible device 145. For example, a receptive state may be determined based on location sensors (e.g., GPS sensor 242) as well as wireless communication sensors (e.g., WiFi 232), detecting that user 190 is heading in the general direction of the store, triggering the preloading of a flyer, but the flyer may only be displayed after additional sensors confirm the receptive state. For example, an accelerometer 246 and a gyroscope 248 may detect that the network accessible device 145 is being brought up from a pocket to a reading position, triggering a prompt on a lock screen of the device, and the ad is only displayed after user 190 interacts with the prompt. In various examples, readings from one or more of compass 240, GPS sensor 242, altimeter 244, accelerometer 246, and gyroscope 248 may provide location and movement device attributes. For example, GPS may indicate that a device is moving along a road way, while accelerometer and gyroscope data may distinguish between vehicles (e.g., bus, car, motorcycle, or bicycle). For example, data may be aggregated showing multiple devices in close proximity with very similar acceleration profiles, indicating multiple devices on one vehicle (e.g., a bus). In another example, a different acceleration profile from neighboring devices may indicate a smaller vehicle (e.g., a car or motorcycle). In the example, if the device is able to move while a plurality of surrounding devices are stopped, it may indicate a motorcycle over a car. The addition of vertical or cyclical movement data (e.g., measured via gyroscope) may indicate a cycling or jogging user.

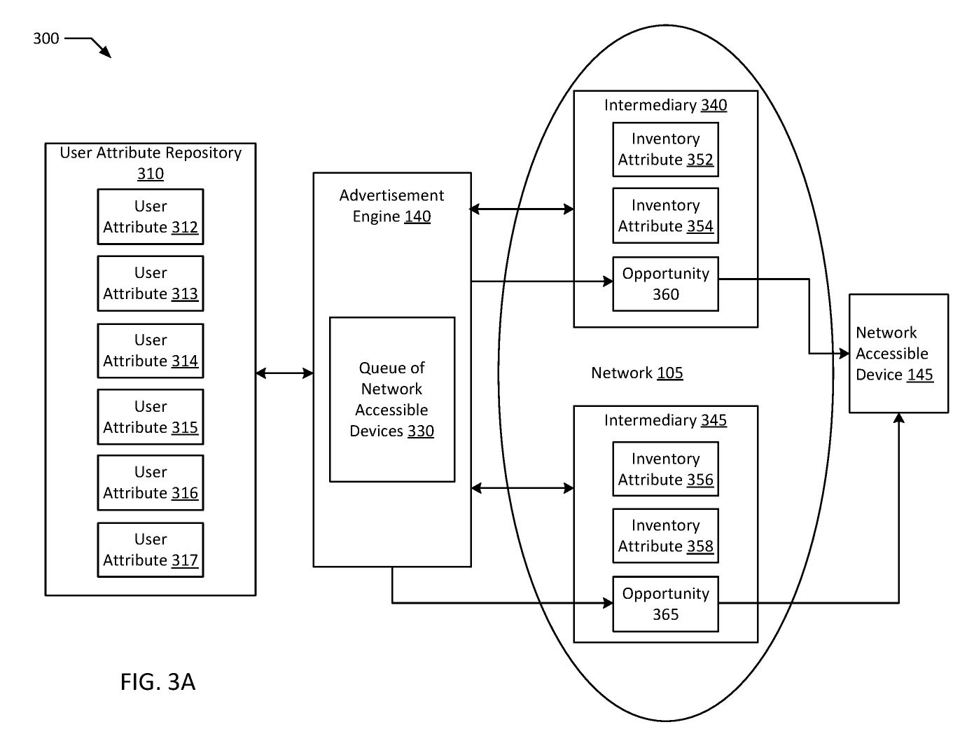

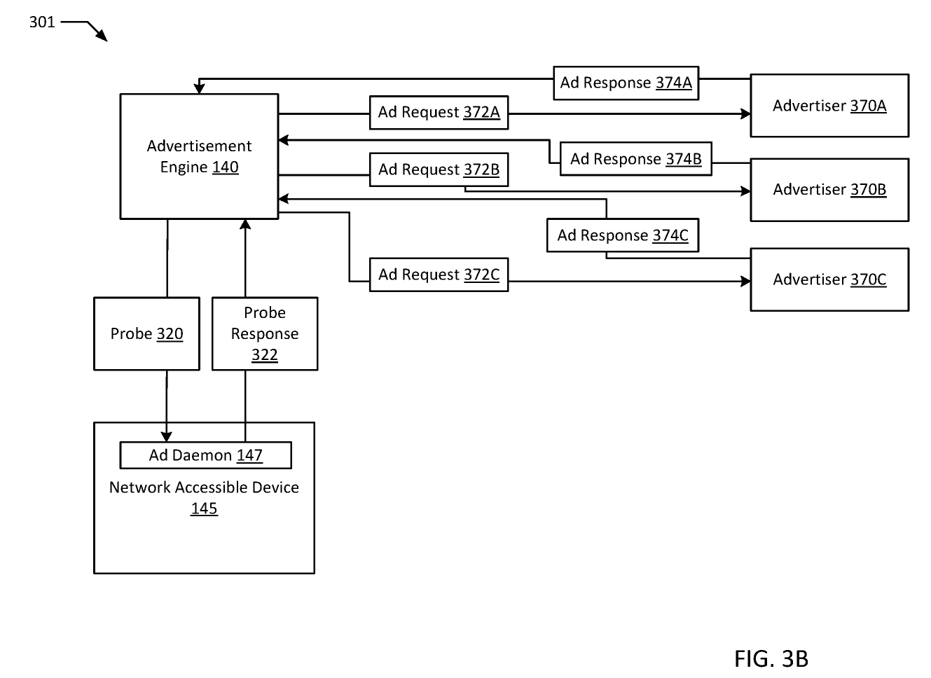

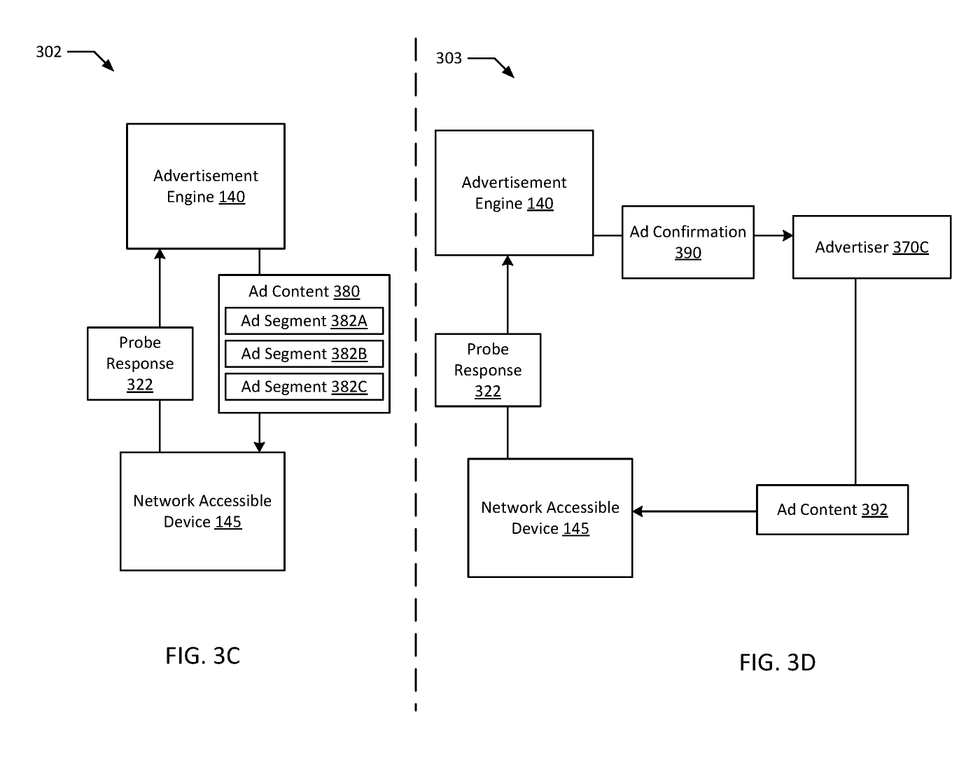

FIGS. 3A-D are block diagrams of a real-time technographic advertisement system according to an example of the present disclosure. In illustrated example system 300 in FIG. 3A, advertisement engine 140 may execute on any virtual or physical hardware connected to network 105. In an example, advertisement engine 140 may be a dedicated component serving network accessible device 145, (e.g., a service executing in a dedicated isolated guest such as a virtual machine or container), or advertisement engine 140 may be a generic component or service serving a large plurality of network accessible devices. In the dedicated example, a plurality of advertisement engines may be communicatively coupled with each other, or may share common data storages. In an example, advertisement engine 140 may be connected with a user attribute repository 310. In the example, user attribute repository 310 may further include user attributes 312-317. In an example, user attribute repository 310 may be stored in any suitable type of database, for example, a relational database. The user attribute repository 310 may be stored in a database associated with a database management system (DBMS). A DBMS is a software application that facilitates interaction between the database and other components of the system 300. For example, a DMBS may have an associated data definition language describing commands that may be executed to interact with the database. Examples of suitable DMBS's include MariaDB®, PostgreSQL®, SQLite®, Microsoft SQL Server® available from MICROSOFT® CORPORATION, various DBMS's available from ORACLE® CORPORATION, various DBMS's available from SAP® AG, IBM® DB2®, available from the INTERNATIONAL BUSINESS MACHINES CORPORATION, etc. In an example, the user attribute repository 310 may be stored in a database organized as a formal database with a schema such as a relational schema with defined tables, indices, links, triggers, various commands etc. In some examples, user attribute repository 310 may not be organized as a formal database, but may instead be an alternative storage structure capable of holding the information stored in user attribute repository 310, including but not limited to a file, folder, directory, registry, etc. In an example, user attribute repository 310 is stored in non-volatile storage.

In an example, user attributes 312-317 may be organized as records of individual users in user attribute repository 310. For example, user attribute 312 may be user attributes of user 190, including demographic identifying information. In the example, user attribute 312 may include various data points including at least one of a gender, an age, a race, a marital status, an income, a browsing history, a home ownership status, disabilities, a level of education, a employment status, an occupation, a status of having children, a location, a means of transportation, an amount of savings, a religion, and a contractual relationship of user 190. In various examples, a user attribute 312 may be an individual user attribute or data point, and/or the combined records for a given user. In other examples, user attributes 312-317 may be specific demographic identifying user attribute categories (e.g., gender, age, race, marital status, income, browsing history, home ownership status, disabilities, level of education, employment status, occupation, status of having children, location, means of transportation, amount of savings, religion, contractual relationship, etc.). In the examples, user 190 may be listed as an entry in user attribute repository 310 with user 190 specific information under each demographic identifying user attribute category. In an example, advertisement engine 140 may query user attribute repository 310 for candidates to receive an advertisement. In an example, a preliminary selection process for a target audience of an advertisement may query user attribute repository 310 for potential advertisement recipients.

In an example, intermediaries 340 and 345 may be publishers of content. For example, intermediaries 340 and 345 may provide business, political, financial, or sports news. In another example, intermediary 340 may be a dedicated shopping interface, for example, one that provides discounts for stores in the immediate vicinity. In an example, intermediary 340 and intermediary 345 may be competitors. For example, intermediary 340 may be a website such as a search engine, while intermediary 345 may be a news site. In another example, intermediary 340 may be an application on a smart phone or tablet dedicated to accessing intermediary 340 content. In an example, intermediary 345 may be a messaging service or social networking platform. In an example, each intermediary (e.g., intermediaries 340 and 345) will have a plurality of inventory attributes (e.g., inventory attributes 352, 354, 356, and 358). These inventory attributes 352, 354, 356, and 358 may be stored in databases or other suitable data structures associated with the intermediaries 340 and 345. In an example, an inventory attribute may be associated with the intermediary as a whole. For example, inventory attribute 352 may be statistics on the total number of hits intermediary 340 receives in a given time period. In an example, inventory attribute 352 may also be statistics on historical usage such as time of day trends etc. In another example, an inventory attribute 354 may be associated with a particular user (e.g., user 190), where inventory attribute 354 may be include information on a frequency and pacing of user 190's visits to intermediary 340. For example, inventory attribute 354 may indicate that user 190 visits intermediary 340 on average six times a month, including every Sunday, and on average accesses intermediary 340's content long enough for seven full length advertisements to be shown per visit. In an example, each time an intermediary's content (e.g., intermediaries 340 and 345) is accessed from network accessible device 145, at least one opportunity (e.g., opportunities 360 and 365) to present an advertisement may arise. In an example, inventory attribute 356 may be associated with an opportunity 365, for example, intermediary 345 may have collected data on the probability of a user viewing an article giving rise to opportunity 365 of continuing onto a second article and thus adding an additional potential advertising slot to opportunity 365. In an example, inventory attributes may include cost, access rate of intermediary by a user, identity of the intermediary, identity of specific content of the intermediary accessed by a user, and frequency and pacing of content access by a user.

In an example, intermediary 340 and/or 345 may implement a version of advertisement engine 140 (e.g., a publisher engine) that executes similarly to advertisement engine 140 but for purposes of determining content modules to serve to network accessible device 145. In an example, a content segment may be substituted by the publisher engine for an ad opportunity. In an example, content delivery may be paused and/or terminated based on measured device attributes (e.g., network accessible device 145 heading for a tunnel with no signal). In an example, where an advertiser may host a secondary auction for an ad opportunity, a content delivery engine may determine what content to queue to display next. For example, a content delivery engine for videos may preload an advertisement as a content segment, and upon detecting an imminent loss of connectivity, the content delivery engine may replace an upcoming content segment with the advertisement segment to ensure an ad is shown. In the example, a user may miss some or all of the video content due to loss of connectivity underground. In the example, showing the advertisement may be preferable to no content being shown due to lack of buffering.

In an example, intermediaries 340 and 345 may respond to queries from advertisement engine 140 related to whether a given user accesses any content through a given intermediary. In the example, advertisement engine 140 may target an advertisement at single males with sufficient income to afford a luxury car, living in a metropolitan area, who have recently purchased a high end watch. Various filters placed on user attributes (e.g., user attributes 312-317) in user attribute repository 310 may produce a list of users who fit the above criteria demographically. Advertisement engine 140 may then query intermediaries 340 and 345 regarding which users on the list are frequent visitors to each intermediary's offerings. A list of network accessible devices associated with these users may be generated based on either user attributes or inventory attributes mapping a user to a network accessible device (e.g., network accessible device 145). A final list of network accessible devices that advertisement engine 140 may wish to target in a given advertising campaign may then be added to a queue of network accessible devices 330 associated with advertisement engine 140. In an example, intermediaries 340 and 345 may be requested to notify advertisement engine 140 whenever one of the queued network accessible devices accesses content through intermediaries 340 and 345. In another example, advertisement engine 140 may pre-purchase advertising slots in any prospective opportunities 360 and 365 that arise.

In an example, intermediary 340 and/or 345 conducts real-time bidding (e.g., header bidding, supply side platform bidding, OpenRTB bidding, etc.) for its ad opportunities (e.g., opportunities 360, 365). In such examples, intermediary 340 and/or 345 may communicate to advertisement engine 140 the existence of a new opportunity to request for a bid on the opportunity. In such examples, the request for a bid may include less information about the network accessible device 145 and/or user 190 accessing the publisher content than advertisement engine 140 may require to accurately determine a value of the opportunity. In such an example, advertisement engine 140 may query user attribute repository 310 to attempt to predict additional user attributes (e.g., user attributes 312-317) with the information provided in the request for bid. In an example, advertisement engine 140 may enter a bid for opportunity 360 and/or 365 with incomplete information regarding network accessible device 145 and/or user 190, for example, to meet a bidding deadline or timeout. In the example, advertisement engine 140 may have 300 ms to respond with a bid on the ad opportunity, and may not have a conclusive match during the timeout period for a user profile related to the request for bid. In an example, incomplete and/or erroneous metadata information included with the request for bid may contribute to a lack of a matching user profile during the allotted time period.

Illustrated system 301 in FIG. 3B is an example where advertisement engine 140 has won a bid for an opportunity (e.g., opportunity 360 or 365). In the example, advertisement engine 140 may query ad daemon 147 with a probe 320 to verify information about network accessible device 145 and/or user 190. In some examples, for example, where advertisement engine 140 receives sufficient information to predict that it is bidding on an opportunity on network accessible device 145, probe 320 may be sent before advertisement engine 140 responds to the request for a bid. In an example, ad daemon 147 is executing on network accessible device 145 before probe 320 is sent. In such examples, probe 320 may simply be a request for current state (e.g., state 120 or 125). In another example, ad daemon 147 may be included in probe 320 and may execute on network accessible device 145 after probe 320 is received. For example, probe 320 may be an HTML5 or JavaScript script loaded with publisher web content that includes ad daemon 147 as a module that executes in the background while advertisement engine 140 maintains an open network connection with network accessible device 145. In an example, probe response 322 may include a current state 120 or 125 of network accessible device 145. In an example, probe response 322 may include device attributes of network accessible device 145. In an example, probe 320 is an HTML commend to ad daemon 147, which is already executing on network accessible device 145, to send a current receptiveness state of network accessible device 145 to advertisement engine 140.

In an example, especially where advertisement engine 140 is unable to predetermine an identity of network accessible device 145 and/or a current state of network accessible device 145 before bidding on an opportunity, advertisement engine 140 may trigger a secondary auction for an ad to display in the opportunity. For example, substantially simultaneously with sending out probe 320, advertisement engine 140 may send ad requests 372A-C to advertisers 370A-C attempting to find alternative content (e.g., an alternative ad) to display in opportunity 360 or 365. In the example, ad requests 372A-C may be a translated version of the request to bid on opportunity 360 and/or 365, for example, further enriched with predicted user attribute data from user attribute repository 310. In an example, even with incomplete data from the request for bid, advertisement engine 140 may be able to add additional demographic data to ad requests 372A-C based on, for example, historical usage data from intermediaries 340 and 345 (e.g., inventory attributes 352, 354, 356, and 358). In an example, ad responses 374A-C may be received by advertisement engine 140 prior to or shortly after probe response 322. In an example, advertisement engine 140 only responds to a winning advertiser (e.g., advertisers 370A-C) if the advertisement engine 140 determines to forgo displaying its own content (e.g., advertisement 110) in opportunity 360 or 365. In an example, ad responses 374A-C may be received by advertisement engine 140 within 100-400 ms of sending ad requests 372A-C. In the example, if probe response 322 does not return before ad responses 374A-C, advertisement engine 140 may determine that probe response 322 has timed out and therefore that network accessible device 145 is in a non-receptive state, at least for high quality dynamic advertisements.

Illustrated example system 302 in FIG. 3C depicts a first alternative, where probe response 322 indicates that network accessible device 145 is currently susceptible to displaying an ad from advertisement engine 100. In the example, in response to probe response 322, advertisement engine 140 sends ad content 380 including ad segments 382A-C to network accessible device 145. In an example, ad segments 382A-C are sequential segments of a same advertisement. In an example, ad segments 382B and 382C may be alternative endings to the advertisement. In an example, ad segments 382A-C may be different resolution streams of the same advertisement (e.g., portrait, landscape, low definition, high definition, ultra high definition, etc.). In a content delivery example, a content segment when triggered may initiate a round of ad bidding (e.g., header bidding from network accessible device 145, or OpenRTB bidding with an ad exchange).

Illustrated example system 303 in FIG. 3D depicts an alternative to FIG. 3C, where advertisement engine 140 and/or ad daemon 147 determines not to follow through with the delivery of ad content 380, for example, due to network accessible device 145 being in a non-receptive state (e.g., state 125). In an example, in response to probe response 322 (or a lack of receiving probe response 322 prior to a timeout), ad confirmation 390 is sent to winning bidder 370C of advertisement engine 140's secondary auction. Advertiser 370C then sends ad content 392 to be displayed by network accessible device 145 instead. In an example, probe response 322 may also indicate that the opportunity has been cancelled altogether, for example, based on user 190 switching views away from the content generating opportunity 360. In an example, advertisement engine 140 may determine that sending an advertisement to network accessible device 145 is a waste of resources, for example, based on network accessible device 145 entering an area with little to no cellular signal. Similarly, a content engine of a publisher may cancel content delivery based on observed current observed technographic data of network accessible device 145. In an example, advertisement engine 140 informs intermediary 340 and/or 345 of a failure to deliver an advertisement to network accessible device 145 upon cancellation of delivery based on receiving probe response 322. In another example, sending ad confirmation 390 to advertiser 370C effectively cancels advertisement 140's interaction with the opportunity.

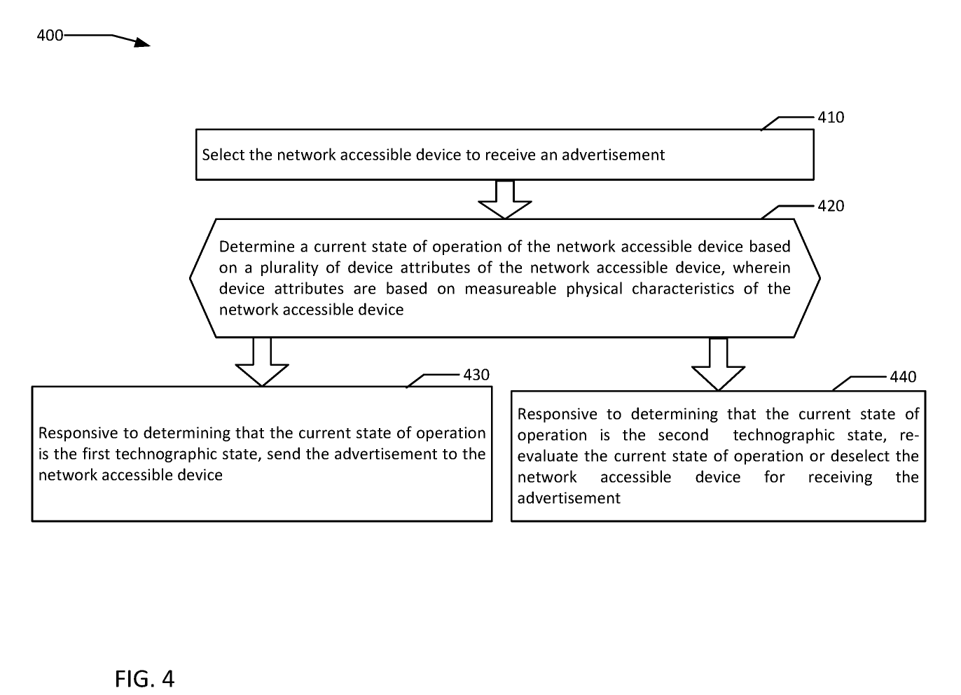

FIG. 4 is a flowchart illustrating an example of real-time technographic advertisement according to an example of the present disclosure. Although the example method 400 is described with reference to the flowchart illustrated in FIG. 4, it will be appreciated that many other methods of performing the acts associated with the method 400 may be used. For example, the order of some of the blocks may be changed, certain blocks may be combined with other blocks, and some of the blocks described are optional. The method 400 may be performed by processing logic that may comprise hardware (circuitry, dedicated logic, etc.), software, or a combination of both. In an example, the method is performed by an advertisement engine 140 in communication with a network accessible device 145.

The example method 400 may begin with an advertisement engine selecting a network accessible device to receive an advertisement (block 410). For example, advertisement engine 140 may have added network accessible device 145 to a queue of network accessible devices 330 to receive an advertisement 110. In the example, network accessible device 145 may have been identified to have at least one user 190, who may be a part of a target demographic for advertisement 110. For example, user attributes (e.g., user attributes 312-317) associated with user 190 may identify user 190 as a woman between 25 and 40 who habitually jogs with monthly disposable income of at least $2,000. In an example, user attributes 312-317 may be collected by a browser cookie associated with user 190, either from network accessible device 145 (e.g., a smart phone) or another network accessible device associated with user 190 (e.g., a desktop computer).

The advertisement engine may determine that the network accessible device is in use by a user. In an example, advertisement engine 140 may determine that user 190 is currently using network accessible device 145. The determination may come from a variety of sources. In an example, user 190 accesses content hosted by intermediary 340, and intermediary 340 in turn notifies advertisement 140 that user 190 is currently engaged with intermediary 340. In another example, advertisement engine 140 may receive periodic updates of device attributes (e.g., device attributes 150, 152, and 154) of network accessible device 145. For example, user 190 may subscribe to an advertisement limiting service provided by advertisement engine 140 that limits the advertisements seen by network accessible device 145 in exchange for better targeted advertisements (e.g., advertisement 110). In an example, radio 232 of network accessible device 145 may come into range of a short wavelength radio receiver at a store, which notifies advertisement engine 140 of the user's local presence, and advertisement engine 140 in turn prepares to send a target advertisement to network accessible device 145 for the particular store. In an example, user 190 launches an application on network accessible device 145 for price checking an item, and the application notifies advertisement engine 145 that network accessible device 145 is in use by user 190. In an example, ad daemon 147 determines that network accessible device 145 is in use and reports the usage state of network accessible device 145 to advertisement engine 140 periodically and/or on demand from advertisement engine 140. In an example, ad daemon 147 may take a plurality of measurements two to ten times per second to determine a current receptiveness state (e.g., states 120, 125) of network accessible device 145 and report any changes in state to advertisement engine 140.

In response to determining that the network accessible device is in use by the user, a current state of operation of the network accessible device is determined based on a plurality of device attributes of the network accessible device, which are based on measureable physical characteristics of the network accessible device (block 420). In an example, network accessible device 145 may operate in different states, such as states 120 and 125. In a simple example, state 120 may indicate that network accessible device 145 is currently receptive to advertising, while state 125 may indicate that network accessible device 145 is currently non-receptive to advertising. In some examples, a plurality of states may exist, where different states may indicate different levels or types of receptiveness to advertising. For example, a smart phone operating with the screen off may be receptive to audio advertising, but not video or image advertising. In such an example, video receptive and audio receptive may be different states. In an example, a bandwidth of a network accessible device's connection to network 105 may indicate different states (e.g., whether high definition or low definition advertisements may be used). In an example, a plurality of available versions of advertisement 110 may factor into determining whether network accessible device 145 may be in a receptive state 120 or a non-receptive state 125. For example, if advertisement 110 is only available in a high definition, landscape format, the required device attributes for receptive state 120 may be very different from if advertisement 110 were also available in low resolution and portrait formats. In an example, to reach a broader variety of network accessible devices, advertisement 110 may be produced with a plurality of versions. In an example, advertisement 110 may be produced in at least four major versions (e.g., not including minor versions to fit the resolutions of similar sized screens). For example, a motion picture version, a still image version, an audio version, and a text version of advertisement 110 may be produced for the same advertisement. In a further example, different videos and images may be produced for landscape vs. portrait orientation, and at different resolutions (e.g., for different sized files and different network connection bandwidths). In an example, the current state of operation of network accessible device 145 may be continually evaluated from the time network accessible device 145 is selected as a target for advertisement 110, until advertisement 110 is finished being displayed.

In an example, advertisement engine 140 may have an opportunity to cancel a particular advertisement slot purchase in a particular opportunity (e.g., opportunity 360 or 365) up to a point in time where advertisement 110 starts being presented on network accessible device 145. In such an example, to efficiently display advertisement 110, advertisement engine 140 may periodically query physical characteristics (e.g., physical characteristics 170, 172, 174, and 176) and device attributes (e.g., device attributes 150, 152, and 154) of network accessible device 145 to determine a then current state of operation of network accessible device 145 (e.g., state 120 or 125). In an example, advertisement engine 140 may notify intermediary 340 that it wishes to buy the second ad slot to present an ad to network accessible device 145 in opportunity 360 (e.g., reading a news article on a news site). In the example, the second ad slot may correspond with a follow on click to a second article. In an example, advertisement engine 140 may be required to make a final determination to go forward when a link to the second article is clicked. At that point, advertisement engine 140 may once again evaluate the current state of operation of network accessible device 145. In an example, ad daemon 147 may constantly monitor the current state of operation of network accessible device 145. For example, while network accessible device 145 is displaying content from intermediaries 340 and/or 345, ad daemon 147 may periodically poll one or more of sensors 160, 162, 164, 166, physical characteristics 170, 172, 174, 176, and/or device attributes 150, 152, 154 for current values. In the example, ad daemon 147 may implement separate worker threads with delay timers to poll each monitored attribute. In an example, current state (e.g., states 120, 125) may be determined based on the most current values of each polled attribute. In an example, a delay in updating of one or more attributes being monitored may be indicative of network accessible device 145 being in a non-receptive state (e.g., an application is hanging or crashed). In an example, polling may be conducted frequently (e.g., three times per second or more). In an example, certain sensors may be set to elevated states by ad daemon 147 (e.g., a GPS sensor set for maximum accuracy) which result in more frequent updates of physical characteristics measured by those sensors, which results may be retrieved and/or monitored by ad daemon 147.

In response to determining that the current state of operation is in the first state, the advertisement is sent to the network accessible device (block 430). In an example, the advertisement engine 140 determines that network accessible device 145 is in a receptive state 120 based on network accessible device 145 having a solid network connection along with network accessible device 145 being relatively motionless. In the example, advertisement engine 140 may notify intermediary 340 confirming advertisement engine 140's intention to buy the second advertisement slot of network accessible device 145's current session viewing intermediary 340's content (e.g., opportunity 360). In the example, a portrait oriented video version of advertisement 110 may be shown on network accessible device 145. In an example, the portrait oriented video version of advertisement 110 may be selected based on device attributes 150, 152, and 154 indicating that network accessible device 145 was in the portrait orientation, connected to WiFi, and sound was enabled on network accessible device 145.

In response to determining that the current state of operation is the second state, reevaluate the current state of operation or deselect the network accessible device for receiving the advertisement (block 440). In an example, the advertisement engine 140 may determine that network accessible device 145 is in a non-receptive state 125 based on a variety of device attributes. In such examples, the advertisement engine 140 may choose to wait and reevaluate the current state of operation of network accessible device 145 or to remove network accessible device 145 from the queue of network accessible devices 330. For example, a weak connection to network 105 may place network accessible device 145 in a non-receptive state 125. In another example, device attributes related to the motion of network accessible device 145 may show that network accessible device 145 is in a state of turbulent motion (e.g., user 190 may be running or jogging), placing network accessible device 145 in a non-receptive state 125. In yet another example, a bio-metric reading (e.g., a finger print, facial recognition reading, microphone voice print, or genetic scan via blood, skin cells, saliva and/or hair) may indicate that a current user of network accessible device 145 is not user 190 (e.g., gender, hair color, finger print, voice print or genetic mismatch), resulting in network accessible device 145 being placed in non-receptive state 125. In an example, advertisement engine 140 indicates to a secondary advertiser, (e.g., advertisers 370A-C) that the secondary advertiser has successfully obtained an ad opportunity (e.g., via ad confirmation 390) and the secondary advertiser 370C sends ad content 392 to network accessible device 145 based on advertisement engine 140 determining that network accessible device 145 is in a non-receptive state.

In an example, after network accessible device 145 is determined to be in non-receptive state 125, advertisement engine 140 may indicate to intermediary 340 that it no longer wishes to obtain the second advertisement slot in opportunity 360, and would be willing to await another opportunity. In an example, network accessible device 145 may link to a sixth article of intermediary 340's content, and intermediary 340 may query advertisement engine 140 if advertisement engine 140 would be willing to procure the sixth advertisement slot of opportunity 360. In the example, network accessible device 145 which previously had a weak connection to network 105 may have moved into range of a WiFi network. In such an example, advertisement engine 140 may determine that device attributes (e.g., device attributes 150, 152, and 154) of network accessible device 145 have change sufficiently to change network accessible device 145 from the non-receptive state 125 to the receptive state 120. With the change in current operational state, advertisement engine 140 may procure the sixth advertisement slot of opportunity 360 and display the advertisement 110 on network accessible device 145.

In another example, advertisement engine 140 may remove network accessible device 145 from the queue of network accessible devices 330. For example, after a certain threshold quantity of opportunities pass for showing advertisement 110 to network accessible device 145 without network accessible device 145 being in the receptive state 120, network accessible device 145 may be deselected from receiving advertisement 110. Alternatively, prior to network accessible device 145 being in a receptive state 120 during an opportunity (e.g., opportunities 360 and 365) to show advertisement 110, a quantity limit of showings for advertisement 110 and/or a budget for an advertising campaign featuring advertisement 110 may be exhausted. In an example, network accessible device 145 may be removed from the queue of network accessible devices 330 as soon as advertisement engine 140 determines network accessible device 145 is in the non-receptive state 125 (e.g., in a very time limited advertising campaign).

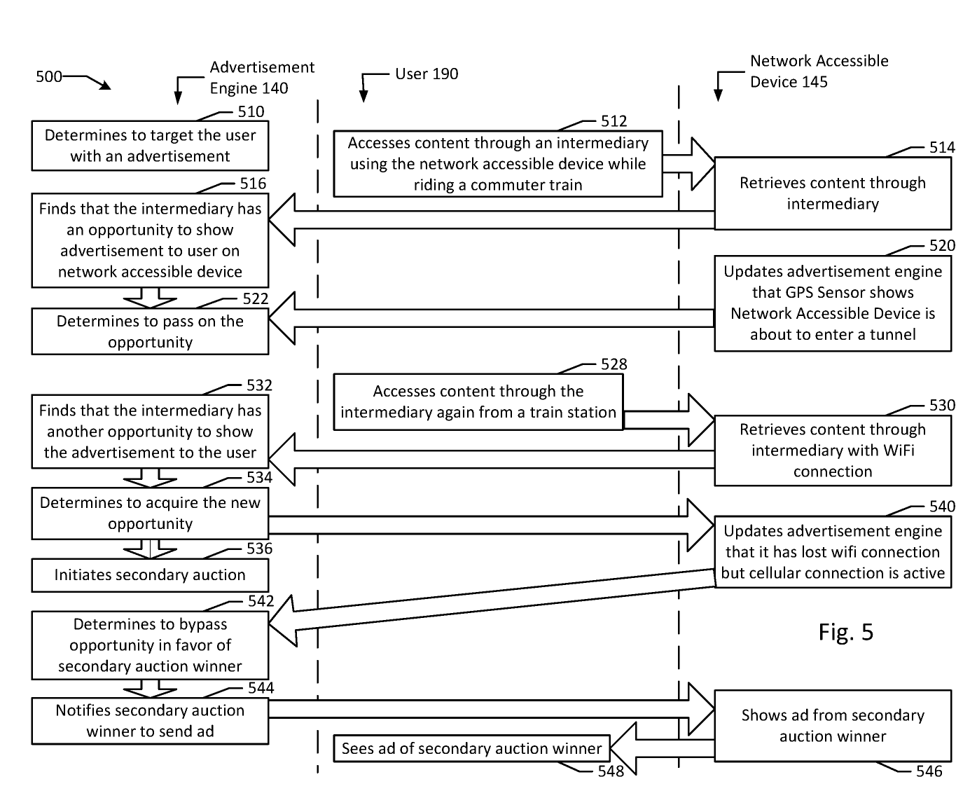

FIG. 5 is a flow diagram illustrating advertisement delivery based on a state of a network accessible device according to an example of the present disclosure. Although the examples below are described with reference to the flowchart illustrated in FIG. 5, it will be appreciated that many other methods of performing the acts associated with FIG. 5 may be used. For example, the order of some of the blocks may be changed, certain blocks may be combined with other blocks, and some of the blocks described are optional. The methods may be performed by processing logic that may comprise hardware (circuitry, dedicated logic, etc.), software, or a combination of both. In example system 500, a user 190 operating network accessible device 145 is the target of advertisement engine 140.

In an example, advertisement engine 140 determines to target user 190 with an advertisement 110 (block 510). For example, user attributes (e.g., user attributes 312-317) in user attribute repository 310 may indicate that user 190 falls into a target demographic for advertisement 110 (e.g., user 190 may be a professional woman between 25 and 40 with a monthly disposable income of at least $2,000). In the example, advertisement 110 may be an advertisement for a luxury handbag. In the example, user 190 may access content (e.g., an entertainment article) through an intermediary 345 using network accessible device 145 while riding on a commuter train to work (block 512). In conjunction with accessing content, network accessible device 145 may communicate device attributes to advertisement engine 140, either directly or indirectly a plurality a device attributes with which a state of network accessible device 145 may be determined. In the example, with a strong cellular connection and steady, low acceleration movement, network accessible device 145 is determined to be in a receptive state 120. Network accessible device 145 may then retrieve the requested content through intermediary 345 (block 514). In an example, advertisement engine 140 may then find out that intermediary 345 has an opportunity 365 to show advertisement 110 to user 190 on network accessible device 145 (block 516). For example, intermediary 345 may notify advertisement engine 140 of opportunity 365. In an example, network accessible device 145 may update advertisement engine 140 that a GPS sensor 242 indicates that network accessible device 145 is about to enter a tunnel (block 520). In an example, advertisement engine 140 may query network accessible device 145 for device attributes to determine a current operational state of network accessible device 145. In the example, based on accelerometer 246 data received from network accessible device 145, advertisement engine 140 may determine that network accessible device 145 is on a train and not a car. Additionally, based on GPS sensor 242 data, combined with map data from a map database, advertisement engine 140 may determine that network accessible device 145 is about to enter a railway tunnel with no cellular signal. Based on the GPS sensor 242 data and the accelerometer 246 data, advertisement engine 140 may determine that network accessible device 145 is currently in a non-receptive state 125. Based on the non-receptive state 125, advertisement engine 140 may determine to pass on the opportunity 365 (block 522).

In a continuation of the example above, user 190 may access content through intermediary 345 again from a train station (block 528). In an example, the train station may be outfitted with WiFi hotspots providing WiFi connectivity to network 105 (e.g., the internet). Network accessible device 145 may retrieve content through intermediary 345 again, this time with a WiFi connection using WiFi interface 234 (block 530). In an example, advertisement engine 140 finds that intermediary 345 has a new opportunity to show advertisement 110 to user 190 (block 532). In the example, based on sensor data (e.g., from accelerometer 246, GPS sensor 242, and gyroscope 248) showing relatively little motion, advertisement engine 140 may determine that network accessible device 145 is in a receptive state 120. As a result, advertisement engine 140 determines to acquire the new opportunity to show advertisement 110 from intermediary 345 (block 534). In an example, based on a strong WiFi connection with high bandwidth, a high resolution video version of advertisement 110 is selected to be shown on network accessible device 145. In an example, when advertisement engine 140 determines to acquire the ad opportunity on network accessible device 145, advertisement engine 140 initiates a secondary auctino for the opportunity (e.g., sending ad requests 372A-C to advertisers 370A-C) (block 536).

In an example, Network accessible device 145 updates advertisement engine 140 that it has lost its WiFi connection but that a cellular connection remains active before ad content is loaded from advertisement engine 140 (block 540). For example, advertisement engine 140 may have probed network accessible device 145 for its current state of receptiveness first before sending ad content. In the example, advertisement engine 140 determines that it will bypass the ad opportunity on network accessible device 145 in favor of the winner of the secondary auction (e.g., advertiser 370C) (block 542). In the example, advertisement engine 140 notifies advertiser 370C that it has won the ad opportunity and that an ad should be sent to network accessible device 145 (block 544). In an example, advertisement engine 140 notifies advertiser 370C to send an ad to network accessible device 145 directly. In another example, advertisement engine 140 serves as a conduit for ad content 392 from advertiser 370C. In the example, publisher 345 and network accessible device 145 may be unable to determine that ad content 392 is from a secondary auction winner and not advertisement engine 140. In an example, network accessible device 145 shows the ad from the secondary auction winner advertiser 370C (block 546). In an example, user 190 then sees the ad (e.g., ad content 392) of advertiser 370C (block 548).4

In an alternative example, prior to advertisement 110 being received by network accessible device 145, WiFi connectivity is lost but advertisement engine 140 determines to keep the ad opportunity (e.g., the secondary auction failed to return satisfactory bids or the secondary auction timed out). In the example, network accessible device 145 may update advertisement engine 140 that WiFi connection has been lost but a cellular connection is still active. In an example, the loss of WiFi connection may reduce the network bandwidth of network accessible device 145 sufficiently such that advertisement engine 140 determines to send a low resolution version of advertisement 140 to network accessible device 145 rather than an originally planned high resolution version. In an example, network accessible device 145 shows the low resolution version of advertisement 110 to user 190. In the example, user 190 sees the low resolution version of the advertisement.

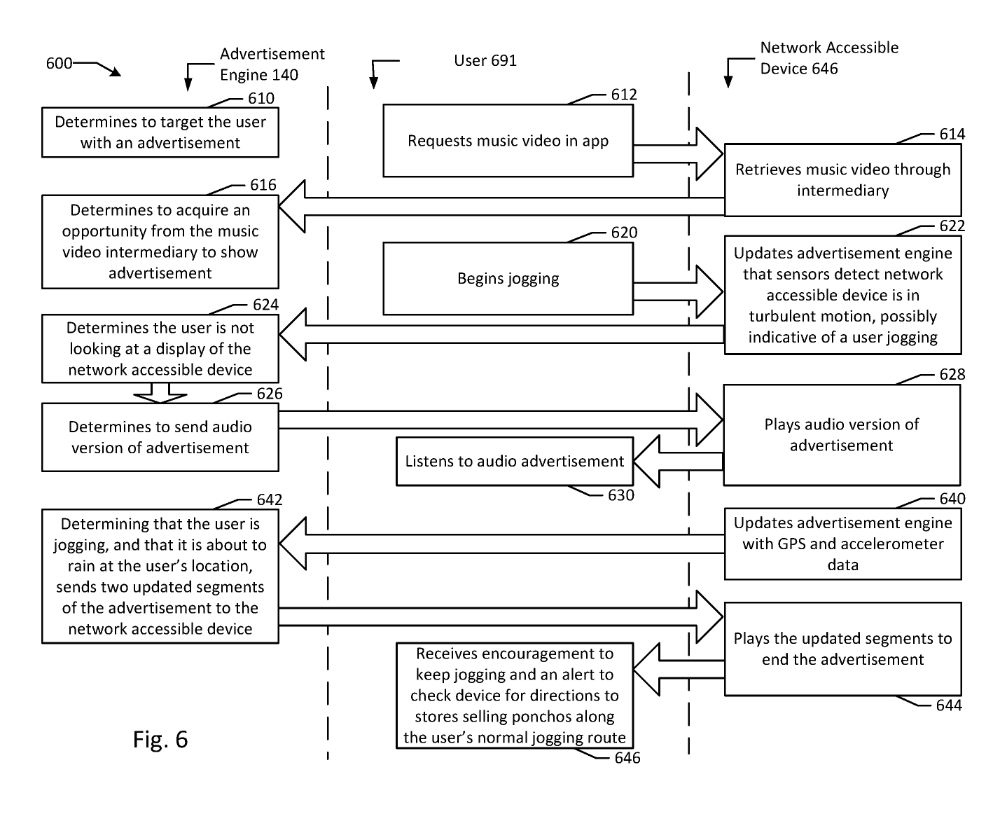

FIG. 6 is a flow diagram illustrating reactive advertisement delivery based on device attributes of a network accessible device according to an example of the present disclosure. Although the examples below are described with reference to the flowchart illustrated in FIG. 6, it will be appreciated that many other methods of performing the acts associated with FIG. 6 may be used. For example, the order of some of the blocks may be changed, certain blocks may be combined with other blocks, and some of the blocks described are optional. The methods may be performed by processing logic that may comprise hardware (circuitry, dedicated logic, etc.), software, or a combination of both. In example system 600, a user 691 operating network accessible device 646 is the target of advertisement engine 140.

In an example, advertisement engine 140 determines to target user 691 with an advertisement (block 610). For example, user attributes in user attribute repository 310 may indicate that user 691 falls into a target demographic for an advertisement (e.g., user 691 may be a professional man between 30 and 45 with a monthly disposable income of at least $5,000 who habitually exercises). In the example, the advertisement may be an advertisement for running shoes. In an example, user 691 may request a music video through an app on network accessible device 646 (e.g., a smart watch) (block 612). In the example, network accessible device 646 retrieves the music video through an intermediary that provides the music video app (block 614). In an example, advertisement engine 140 may be notified about the music video streaming by user 691 through either network accessible device 646 or through the intermediary (e.g., publisher or video streaming company). In an example, an expedited determination that network accessible device 646 is in a receptive state 120 may be made based on the content that is being delivered to the device (e.g., a music video). Advertisement engine 140 may then determine to acquire an opportunity from the music video intermediary to show the running shoe advertisement (block 616). In an example, advertisement engine 140 may determine based on then known device attributes (e.g., video streaming, with sound on and sent to headphones), that network accessible device 646 was in a receptive state 120.

In an example, user 691 begins jogging (block 620). Network accessible device 646 may then update advertisement engine 140 that sensors (e.g., accelerometers and gyroscopes) detect that network accessible device 646 is in turbulent motion, possibly indicative of user 691 jogging (block 622). For example, network accessible device 646 may detect that in addition to moving GPS locations based on a GPS sensor, network accessible device 646 is also traveling in a vertical elliptical motion, indicative of a runner swinging their arms. In an example, based on the newly updated device attributes from network accessible device 646, advertisement engine 140 may determine that user 691 is not looking at the display of network accessible device 646 (block 624). In some examples (e.g., where only image and video versions of the running shoe advertisement exist), advertisement engine 140 may determine to pass on the opportunity, as network accessible device 646 would be in a non-receptive state due to the limited available versions of the advertisement. In an example, based on the updated device attributes, advertisement engine 140 may determine to send an audio version of the running shoe advertisement instead (block 626). In the example, network accessible device 646 may be determined to be in a limited receptive state (e.g., video unavailable). In an example, network accessible device 646 may play the audio version of the running shoe advertisement (block 628). The user 691 may have their music interrupted to listen to the audio advertisement (block 630). In some examples, advertisement engine 140 may determine to send a different version of the ad based on detecting that user 691 is currently jogging (e.g., as compared to if user 691 was on the couch). In an example, the currently jogging ad may include motivational personal trainer type language, while the ad that plays if user 691 were on the couch may be a video ad of joggers on an open road, encouraging user 691 to go jogging.

In an example, network accessible device 646 may further update advertisement engine 140 with GPS and accelerometer data (block 640). Advertisement engine 140 may determine that the user 691 is jogging, and that it is about to rain in user 691's location, thereby triggering the sending of two updated segments of the running shoe advertisement to the network accessible device (block 642). For example, advertisement engine 140 may query local weather reports regarding the GPS location of network device 646. In an example, network accessible device 646 may play the updated segments to end the running shoe advertisement (block 644). In some examples, the updated segments may be added to an existing end of the running shoe advertisement. In other examples, the updated segments may be alternatives to a default ending of the running shoe advertisement. In an example, upon confirming that user 691 is currently jogging, advertisement engine compiles one updated advertisement segment to include encouragement for user 691 (e.g., how far and fast user 691 has run in the past month, how many calories are being burned in the current session, etc.). Upon detecting the possibility of rain, advertisement engine 140 may prepare a second updated segment including an alert about the rain, and possible stores to buy a poncho from based on user 691's normal jogging route. In the examples, user 691 then receives encouragement to keep jogging and an alert to check network accessible device 646 (e.g., the display of the smart watch) for directions to stores selling ponchos along user 691's normal jogging route (block 646). In an example, an entire default ad including all default segments of the running shoe advertisement may be loaded to network accessible device 646 simultaneously to avoid potential loss of connectivity issues as the advertisement plays. In another example, the default behavior may be to segmentally buffer the advertisement to reduce total bandwidth usage in cases where certain segments of an advertisement may be customized for a particular user (e.g., user 691). For example, the default version of the running shoe advertisement may have been a video advertisement that included encouragement to go running based on user 691 not having run in two days, combined with talk of bright sunny days. In the example, based on a determination that user 691 is currently jogging, the video ad may have been replaced with an audio ad, and the original ending segments may be replaced with encouragement to keep running towards a personal goal distance, and sale data for ponchos in the local area. In an example, the replacement of segments may be triggered based on changing device attributes based on physical characteristics measured by network device 646's sensors. In an example, in response to the detection of rain, an updated ad including a segment on a new “slip resistant” all-weather running shoe may be displayed.

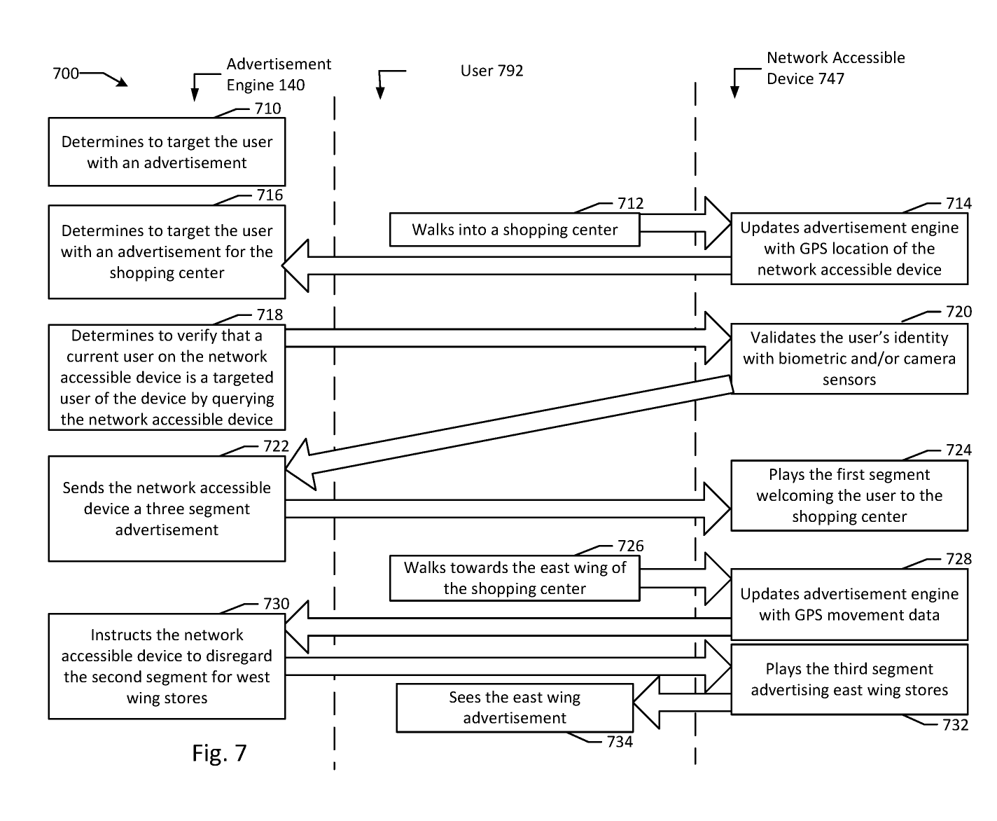

FIG. 7 is a flow diagram illustrating location sensitive advertisement delivery according to an example of the present disclosure. Although the examples below are described with reference to the flowchart illustrated in FIG. 7, it will be appreciated that many other methods of performing the acts associated with FIG. 7 may be used. For example, the order of some of the blocks may be changed, certain blocks may be combined with other blocks, and some of the blocks described are optional. The methods may be performed by processing logic that may comprise hardware (circuitry, dedicated logic, etc.), software, or a combination of both. In example system 700, a user 792 operating network accessible device 747 is the target of advertisement engine 140.

In an example, advertisement engine 140 determines to target user 792 with an advertisement (block 710). For example, user attributes in user attribute repository 310 may indicate that user 792 falls into a target demographic for an advertisement (e.g., user 792 may be a married man between 30 and 45, with a tendency to impulse shop, and a monthly disposable income of at least $2,500). In the example, the advertisement may be an advertisement for a shopping center. In an example, user 792 may walk into a shopping center (block 712). In the example, network accessible device 747 may update advertisement engine 140 with a GPS location of the network accessible device 747 (block 714). For example, as a compulsive impulse shopper who looks for deals, user 792 may subscribe to newsletters for deals from a company operating advertisement engine 140. In the example, upon notice that user 792 has entered the shopping center, advertisement engine 140 may determine to target user 792 with an advertisement for the shopping center. In an example, due to user 792's relationship with advertisement engine 140's company, advertisement engine 140 may send an advertisement directly to network accessible device 747 without an intermediary. In an example, accelerometers and gyroscopes in network accessible device 747 may forward data allowing ad engine 140 to determine that network accessible device 747 has been moved into a reading position and is therefore in a receptive state.

In an example, advertisement engine 140 may determine to verify that the current user of network accessible device 747 is the targeted user 792 by querying the network accessible device (block 718). In an example, certain sales may be limited to registered subscribers. Network accessible device 747 may then validate the user 792's identity with biometric and/or camera sensors (block 720). Upon validation, advertisement engine 140 may send the network accessible device 747 a three segment advertisement (block 722). Network accessible device 747 may play the first segment welcoming the user to the shopping center (block 724). In an example, user 792 may begin walking towards the east wing of the shopping center (block 726). Network accessible device 747 may update advertisement engine 140 with GPS sensor movement data of network accessible device 747 (block 728). In an example, advertisement engine 140 may instruct network accessible device 747 to disregard the second segment of the advertisement previously delivered to network accessible device 747 which focuses on west wing stores (block 730). In an example, network accessible device 747 may then play the third segment of the advertisement advertising east wing stores (block 747). As a result, user 792 may see the advertisement for the east wing stores as he walks by the respective stores (block 734).

In various examples, by responding to device attributes of network accessible devices dynamically while preparing and displaying advertisements, a system executing real-time technographic advertisement may reduce computing overhead on network accessible devices. For example, with better advertisement targeting, a user may be exposed to less advertisements total, while producing similar purchase rates of advertised products. By reducing the number of advertisements displayed, battery usage and network data usage of network accessible devices may be reduced, thereby also reducing energy wasted as heat. Advertisements tend to be graphically intensive, and therefore tend to consume more compute resources to display than the content featuring the advertisements, so a reduction in overhead spent displaying advertisements allows for longer and smoother operation of a network accessible device as a content distributor.

In addition, with real-time updates of device attributes, engagement statistics for advertisements may be better computed for an advertising agency, resulting in more efficient advertising campaigns. Being able to determine whether an imminent change in technographic state may render an opportunity to display an advertisement moot may also allow advertising agencies to display advertisements more efficiently. With increased efficiency, and targeting based on the predicted needs of a user, advertisements may also become more of a helpful tool in a shopping experience rather than an annoyance to be dealt with by a user.

It will be appreciated that all of the disclosed methods and procedures described herein can be implemented using one or more computer programs or components. These components may be provided as a series of computer instructions on any conventional computer readable medium or machine readable medium, including volatile or non-volatile memory, such as RAM, ROM, flash memory, magnetic or optical disks, optical memory, or other storage media. The instructions may be provided as software or firmware, and/or may be implemented in whole or in part in hardware components such as ASICs, FPGAs, DSPs or any other similar devices. The instructions may be executed by one or more processors, which when executing the series of computer instructions, performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system comprising:
a network accessible device, wherein the network accessible device operates in at least one of a first state and an second state;
one or more processors communicatively coupled with a network;
an advertisement engine executing on the one or more processors to:
select, by the advertisement engine, the network accessible device to receive an advertisement;
determine a current state of operation of the network accessible device based on a plurality of device attributes of the network accessible device, wherein device attributes are based on measureable physical characteristics of the network accessible device;
responsive to determining that the current state of operation is the first state, send by the advertisement engine, the advertisement to the network accessible device; and
responsive to determining that the current state of operation is the second state, the advertisement engine one of re-evaluates the current state of operation and deselects the network accessible device for receiving the advertisement.

2. The system of claim 1, wherein the plurality of device attributes are based on output from at least one of an accelerometer, an activity tracker, an altimeter, an antenna, an audio jack, a battery, a biometric sensor, a camera, a compass, a Global Positioning System sensor, a gyroscope, and a radio.

3. The system of claim 1, wherein an advertisement daemon executing on the network accessible device periodically monitors the plurality of device attributes.

4. The system of claim 1, wherein the advertisement has a plurality of versions including a first version of the advertisement, a second version of the advertisement, a third version of the advertisement, a fourth version of the advertisement, a fifth version of the advertisement, a sixth version of the advertisement, and a seventh version of the advertisement.

5. The system of claim 4, wherein the first version of the advertisement is a high resolution landscape motion picture version of the advertisement, the second version of the advertisement is a high resolution portrait motion picture version of the advertisement, the third version of the advertisement is a low resolution landscape motion picture version of the advertisement, the fourth version of the advertisement is a low resolution portrait motion picture version of the advertisement, the fifth version of the advertisement is a still image version of the advertisement, the sixth version of the advertisement is a text based advertisement, and the seventh version of the advertisement is an audio advertisement.

6. The system of claim 4, wherein the advertisement engine selects a version of the plurality of versions of the advertisement to send to the network accessible device based on a first device attribute of the plurality of device attributes.

7. The system of claim 6, wherein the first device attribute is one of a type of the network accessible device, a display type, a display resolution, a geo-location, a movement status, an orientation status, a data transmission speed, a remaining battery capacity, a wireless signal type, and a wireless signal strength.

8. The system of claim 1, wherein the advertisement engine determines that the network accessible device is in turbulent motion based on the plurality of device attributes; and
sends an alternative version of the advertisement to the network accessible device.

9. The system of claim 1, wherein at least one of an identity and a gender of a user is validated with a biometric reading made by at least one of a biometric scanner, a microphone and a camera.

10. The system of claim 1, wherein the advertisement is comprised of a plurality of advertisement segments including a first advertisement segment, a second advertisement segment, and a third advertisement segment.

11. The system of claim 10, wherein the third advertisement segment is an alternative version of the second advertisement segment.

12. The system of claim 11, wherein a change to at least one device attribute of the plurality of device attributes one of before and during a playback of the advertisement causes the network accessible device to play the third advertisement segment in place of the second advertisement segment.

13. The system of claim 1, wherein the advertisement engine selects the network accessible device based on a physical location of the network accessible device.

14. The system of claim 1, wherein the advertisement engine sends the advertisement to the network accessible device through an intermediary.

15. The system of claim 14, wherein the intermediary is one of a website, a search engine, an application, and a messaging service.

16. The system of claim 14, wherein there is a plurality of inventory attributes, including at least one of a cost, an access rate of the intermediary by a user, and an identity of the intermediary.

17. The system of claim 1, wherein upon re-evaluation of the current state of operation, the advertisement engine sends the advertisement to the network accessible device.

18. The system of claim 1, wherein the advertisement engine enters the network accessible device into a queue for receiving the advertisement and the advertisement engine removes the network accessible device from the queue upon determining that the current state of operation is the second state.

19. The system of claim 1, wherein the network accessible device is determined to be in use by a user prior to determining the current state of operation.

20. The system of claim 1, wherein the advertisement engine sends a request for alternative content to a plurality of content providers after selecting the network accessible device to receive the advertisement.

21. The system of claim 20, wherein the plurality of content providers is a plurality of advertisers.

22. The system of claim 20, wherein an alternative content from the plurality of content providers is sent to the network accessible device after the network accessible device is deselected for receiving the advertisement.

23. A method comprising:
selecting a network accessible device to receive an advertisement;
determining a current state of operation of the network accessible device based on a plurality of device attributes of the network accessible device, wherein device attributes are based on measureable physical characteristics of the network accessible device;
responsive to determining that the current state of operation is a first state, sending the advertisement to the network accessible device; and
responsive to determining that the current state of operation is a second state, one of re-evaluating the current state of operation and deselecting the network accessible device for receiving the advertisement.

24. A computer-readable non-transitory storage medium storing executable instructions, which when executed by a computer system, cause the computer system to:
select a network accessible device to receive an advertisement;
determine a current state of operation of the network accessible device based on a plurality of device attributes of the network accessible device, wherein device attributes are based on measureable physical characteristics of the network accessible device;
responsive to determining that the current state of operation is a first state, send the advertisement to the network accessible device; and
responsive to determining that the current state of operation is a second state, one of reevaluate the current state of operation and deselect the network accessible device for receiving the advertisement.
